(19) United States
(12) Patent Application Publication
(10) Pub. No.: US 2024/0385312 A1
(43) Pub. Date: Nov. 21, 2024

(54) DETERMINING THE LOCATIONS OF RFID TAGS

(71) Applicant: Fortiss, LLC, Los Angeles, CA (US)

(72) Inventors: Forrest S. Seitz, Beaverton, OR (US); Tyler J. Seitz, Portland, OR (US); Joshua K. Hoyt, Portland, OR (US)

(21) Appl. No.: 18/665,943

(22) Filed: May 16, 2024

Related U.S. Application Data
(60) Provisional application No. 63/502,789, filed on May 17, 2023.

(51) Int. Cl. G01S 13/87; G01S 13/75; G07F 17/32

(52) U.S. Cl. CPC G01S 13/878; G01S 13/758; G07F 17/322

(57) ABSTRACT

System and method of quickly determining the locations of radio-frequency identification (RFID) tags. Instead of determining the locations based on receiving a full response to the read command, the system uses the initial tag response, which enables it to operate more quickly as part of an initial scan. The system then follows up on the initial scan with read commands to read the RFID tag identifier using only the antennas with RFID tags present, as determined by the initial scan. As a result, the time to determine the locations of the RFID tags is reduced.

### CROSS REFERENCE TO RELATED APPLICATIONS

The present application claims the benefit of U.S. Provisional Application No. 63/502,789 for “Determining the Locations of RFID Tags” filed May 17, 2023, which is incorporated herein by reference.

### BACKGROUND

The present invention relates to gaming, and in particular, to a radio frequency identification (RFID) system with an antenna arrangement for detecting the locations of RFID tags on a gaming table.

Unless otherwise indicated herein, the approaches described in this section are not prior art to the claims in this application and are not admitted to be prior art by inclusion in this section.

There are many circumstances wherein it is helpful to know if an item lies within a defined space. RFID can be used to identify items of interest and the volume of the excitation field can be used to define the location. There are times, however, where the fidelity of the spatial and temporal resolution needed is greater than just whether a response was received or not. This is particularly important in casino gaming operations.

Identifying and tracking the location of gaming tokens in real-time on a gaming table has the potential to revolutionize the gaming industry by providing cash management and improved security. Tying this data to specific players allows casinos to create accurate player profiles while simultaneously alleviating the pit boss of mundane tasks that take years of training to hone.

Traditional RFID systems have tried to address the gaming market with limited success. In a typical RFID system, the excitation antenna defines a “working volume” within which the energy projected by the antenna is sufficient to power the RFID tag. This “working volume” is generally poorly defined with the only option to increase/decrease power to adjust the read range. But increasing the power extends the read range in all directions, introducing cross-talk errors when multiple antennas are in close proximity. In such a system, the only way to define a location with sufficient precision so as to know what bet was made is to decrease power; however, this severely limits the sensitivity and may lead to mis-reads.

As one collects the information from the betting tokens (and cards), it is then possible to add “rules” to track proper behavior on the part of dealers and players. However, the appropriate set of rules evolves through different phases of a game. For example, there is a point at which players are no longer allowed to change their bets (typically prior to dealing the cards) and another point at which the game outcome is known (typically when a dealer turns the cards face up (Blackjack) or the dice roll is complete (Craps) or the ball lands in the pocket (Roulette)). One can think of each of these as defining a change in the “game state”.

In previous patents, we have defined examples of these game states and corresponding rules. See, for example, U.S. Pat. Nos. 8,395,507; 8,395,525; 8,432,283; and 11,346,914. These patents describe improvements such as the use of ferrite cores to shape the H-field, and the use of signal strength information to infer spatial coordinates.

Additionally, U.S. Pat. Nos. 9,984,528 and 11,366,974 describe ways to use a network analyzer to increase the speed of RFID read cycles that are critical to the detection of transient “events”. U.S. Pat. No. 11,630,964 describes the use of RFID systems for Roulette tables.

### SUMMARY

Existing products on the market suffer from multiple shortcomings, including limited chip stack heights, very poor discrimination between adjacent betting spots, excessive time to read multiple tags, and higher than acceptable read errors. These shortcomings limit the available technology to games where the betting spots are widely separated, or simply identifying counterfeit tokens prior to their use on a table.

Additionally, although using the network analyzer to detect the reflection coefficient offers a solution to some of these shortcomings, the network analyzer may require complex electronics and-due to high variability of the reflected signals-may be prone to errors. Furthermore, the network analyzer scan does not work well for the case where single chips are present on larger antennas due to the small shift in the scattering parameter S₁₁.

Given the above background and shortcomings of existing products, there is a need to be able to locate gaming tokens accurately on a betting table, and to scan betting spots more quickly so as to capture transient “events”. Additionally, there is a need to identify specific points in time when the system changes from one game state to another and thereby to change the rules being applied.

One goal of the present disclosure is to increase the speed with which a system scans an array of antennas to determine which ones have RFID-enabled betting tokens placed within the read range of each antenna. Another goal of the present disclosure is to be able to quickly read the RFID tags present immediately following a change in game state. As compared to using a network analyzer, embodiments may require less-complex electronics, resulting in comparable performance at lower cost and with increased reliability.

According to an embodiment, a system determines locations of objects in a gaming environment. The system includes a number of RFID antennas arranged at a number of locations on a gaming table, one or more RFID readers coupled to the RFID antennas, and a control system. The control system selects a first selected antenna and controls the one or more RFID readers to perform a scan. Performing the scan includes transmitting a first read command using the first selected antenna. When the one or more RFID readers does not receive a response to the first read command, the control system selects a second selected antenna for scanning. When the one or more RFID readers does receive the response to the first read command, the control system controls the one or more RFID readers to transmit a second read command using the first selected antenna. The response to the first read command includes at least part of an initial tag response and excludes a complete unique item identifier for a given RFID tag, and the response to the second read command includes the initial tag response and the complete unique item identifier for the given RFID tag. Using just the initial tag response during the first read command enables the system to operate more quickly than existing systems that use the complete unique item identifier.

According to an embodiment, a system determines locations of objects in a gaming environment. The system includes a number of RFID antennas arranged at a number of locations on a gaming table, one or more RFID readers coupled to the RFID antennas, and a control system. The control system selects a first subset of the RFID antennas according to a search procedure and controls the one or more RFID readers to perform a scan. The first subset includes two or more of the RFID antennas, and performing the scan includes transmitting a first read command using the first subset. When the one or more RFID readers does not receive a response to the first read command, the control system selects a second subset of the RFID antennas according to the search procedure, where the second subset excludes the first subset. When the one or more RFID readers does receive the response to the first read command, the control system selects a sub-subset of the first subset according to the search procedure and controls the one or more RFID readers to perform a second scan, where performing the second scan includes transmitting a second read command using the sub-subset. When the control system has identified a specific antenna of the sub-subset with at least one RFID tag, the control system controls the one or more RFID readers to transmit a third read command using the specific antenna. The response to the first read command includes at least part of an initial tag response and excludes a complete unique item identifier for a given RFID tag, the response to the second read command includes at least part of the initial tag response and excludes the complete unique item identifier for the given RFID tag, and the response to the third read command includes the initial tag response and the complete unique item identifier for the given RFID tag. Using just the initial tag response during the first and second read commands enables the system to operate more quickly than existing systems that use the complete unique item identifier.

According to an embodiment, a system determines locations of objects in a gaming environment. The system includes a number of RFID antennas arranged at a number of locations on a gaming table, one or more RFID readers coupled to the plurality of RFID antennas, and a control system. The control system stores first information indicating a first subset of the RFID antennas and second information indicating a second subset of the RFID antennas, where each RFID antenna in the first subset is associated with no RFID tags, and each RFID antenna in the second subset is associated with at least one RFID tag. The control system controls the one or more RFID readers to perform a scan using the first subset, where performing the scan includes transmitting a read command using the first subset. When the one or more RFID readers does not receive a response to the read command, the control system leaves unchanged the first information. When the one or more RFID readers does receive the response to the read command, the control system iteratively selects subsets of the first subset, controls the one or more RFID readers to perform the scan of the subsets having been iteratively selected, identifies one or more specific antennas each having at least one RFID tag based on a response to the scan, updates the first information to delete the one or more specific antennas, and updates the second information to add the one or more specific antennas. The response to the read command includes at least part of an initial tag response and excludes a complete unique item identifier for a given RFID tag. The control system selects a selected antenna from the second subset and controls the one or more RFID readers to transmit a second read command using the selected antenna, where the response to the second read command includes the initial tag response and the complete unique item identifier for the given RFID tag.

The following detailed description and accompanying drawings provide a further understanding of the nature and advantages of embodiments of the present invention.

### BRIEF DESCRIPTION OF THE DRAWINGS

FIG. 1 is a block diagram of an RFID system 100.

FIG. 2 is a flow diagram of a method 200 of determining locations of objects in a gaming environment.

FIG. 3 is a block diagram of an RFID system 300.

FIG. 4 is a flow diagram of a method 400 of determining locations of objects in a gaming environment.

FIG. 5 is a block diagram of an RFID system 500.

FIG. 6 is a flow diagram of a method 600 of determining locations of objects in a gaming environment.

FIG. 7 is a block diagram of an RFID system 700.

### DETAILED DESCRIPTION

Described herein are techniques for location determination of RFID tags. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

In the following description, various methods, processes and procedures are detailed. Although particular steps may be described in a certain order, such order is mainly for convenience and clarity. A particular step may be repeated more than once, may occur before or after other steps (even if those steps are otherwise described in another order), and may occur in parallel with other steps. A second step is required to follow a first step only when the first step must be completed before the second step is begun. Such a situation will be specifically pointed out when not clear from the context.

In this document, the terms “and”, “or” and “and/or” are used. Such terms are to be read as having an inclusive meaning. For example, “A and B” may mean at least the following: “both A and B”, “at least both A and B”. As another example, “A or B” may mean at least the following: “at least A”, “at least B”, “both A and B”, “at least both A and B”. As another example, “A and/or B” may mean at least the following: “A and B”, “A or B”. When an exclusive-or is intended, such will be specifically noted (e.g., “either A or B”, “at most one of A and B”).

In this document, the terms “RFID tag”, “RFID gaming tag”, “RFID chip”, “RFID gaming chip”, “gaming chip”, and “gaming token” are used. Such terms are to be read as being broadly synonymous. (More precisely, an “RFID chip” may be used to refer to the integrated circuit components of the “RFID tag”, which also includes additional components such as an antenna, a rigid housing, etc. However, this document is mostly concerned with the broad usage for these terms.) The RFID tag responds to a radio frequency signal from the RFID reader, generally with its serial number or other identifier, enabling the RFID reader to obtain an inventory of the RFID tags in the vicinity. In a gaming context, the RFID gaming tags may be placed on, removed from, or moved around on a gaming table as bets and payouts, according to various game rules. The RFID gaming tags may be marked with a value identifier (e.g., $1).

As described in more detail herein, instead of determining the locations based on receiving a full response to the read command, the system uses the initial tag response, which enables it to operate more quickly as part of an initial scan. The system then follows up on the initial scan with read commands to read the RFID tag identifier using only the antennas with RFID tags present, as determined by the initial scan. As a result, the time to determine the locations of the RFID tags is reduced.

In addition, multiple antennas can be queried sequentially or simultaneously to screen out antennas with no tags and a binary search (or equivalent) method can be used to determine which of the plurality of antennas has tags present. This data (tags vs. no tags) can be used as a priori knowledge to guide subsequent queries.

One of the technical challenges in the design of an antenna closely coupled to one or more tags—as is typical of placing RFID-enabled tags in the excitation field of an RFID reader—is to measure and optimize the impedance matching of the RF devices. This is typically done using a network analyzer to display the scattering parameters (S-parameters)—S₁₁ and/or S₂₂ of a device under test (DUT) on a Smith chart. S-parameters are reflection and transmission coefficients; they will be very familiar to RF and microwave designers and are directly related to impedances and reflection coefficients. Typically, this information is used once as part of a tuning process. Once tuned, the RFID reader is able to detect individual tags as well as larger numbers of tags.

Typical performance is approximately 10 milliseconds per tag (defined by the RFID protocol in use). Thus, for 100 tags on a single antenna, the read cycle is approximately 1 second. In the case where spatial resolution requires the use of multiple antennas (as described in previous patents), a read cycle is required for each antenna whether a tag is present or not. In two important applications—specifically Roulette and Craps—there may be very large numbers of antennas (e.g., more than 300). This may result in read cycles of 3 or more seconds, even though the actual number of tags is much less, and many of the antennas have no tags in their excitation field. Three or more seconds is too long to capture transient events as bets are placed and payouts are made.

The present disclosure uses the term “SPEEDscan” to refer to the systems and methods described herein, and the improvements resulting therefrom. SPEEDscan includes 3 embodiments, referred to as sequential SPEEDscan, multiplexed SPEEDscan, and dynamic SPEEDscan. Each embodiment has stand-alone value. Together, their value is compounded.

### Sequential SPEEDscan

Sequential SPEEDscan is based on the following two insights. First, that the ability to detect the “presence” (vs. the serial number ID) of one or more tags on an antenna can be accomplished using just the initial tag response (ITR). Second, that the read cycle can be terminated after the ITR has been detected by the RFID reader. Given this information, the RFID reader can direct its read cycles to only those antennas where tags are known to be present.

For example: in the ISO/IEC 18000-3:2010 MODE 3 RFID protocol, the steps typically used to determine tag serial numbers are as follows. First, the RFID reader puts out an INVENTORY command (consisting of a SELECT command followed by a BEGIN ROUND command) at full RF power to a single selected antenna. Second, the RFID tag(s) respond with the 16-bit cyclic redundancy check (CRC) of its unique item identifier (UII) and the 5-bit CRC of the command received. Third, the RFID reader responds with an acknowledgement. Fourth, the tag responds with the complete UII. This process typically takes around 10 milliseconds. Thus, these steps constitute the baseline case against which SPEEDscan is measured.

In contrast, Sequential SPEEDscan breaks this process down as follows. First, the RFID reader puts out an INVENTORY command. In one embodiment, this command is issued at low power since it is only necessary to excite a single tag to detect “presence” of at least one tag. In another embodiment, this command is issued at full power.

Second, the RFID tag(s) respond in their normal way-which includes an initial tag response (ITR). The ITR can be further broken down into a PREAMBLE, a START OF FRAME (SOF), and a Check SUM (CRC). The system may use any of these to determine the presence of tags. In one embodiment, the PREAMBLE is used to detect the presence of tags. In another embodiment, the SOF is used to detect the presence of tags. In another embodiment, the CRC is used to detect the presence of tags. In another embodiment, other features of the RFID protocol may be used (e.g., the pilot tone).

Third, the reader either detects the presence of a tag or not. In an embodiment, this detection takes place in 2.5 msec (versus 10 msec for a typical read cycle).

Fourth, after determining whether a tag is present or not, the INVENTORY command is terminated.

Fifth, if tags are present, the INVENTORY command is reissued at full RF power and the tags respond with the complete UII.

Sixth, this process is repeated for each antenna in the array.

In sum, Sequential SPEEDscan leverages an important insight: That an RFID tag response can be broken down into an ITR +DATA, where any part of the ITR can be used to determine the presence of tags without the need to decode the complete response of multiple tags. In this manner, Sequential SPEEDscan greatly speeds up the read cycle for those use cases where a significant percentage of the antennas in an array do not have tags present or where a priori knowledge of tag locations is available (e.g. from a previous scan).

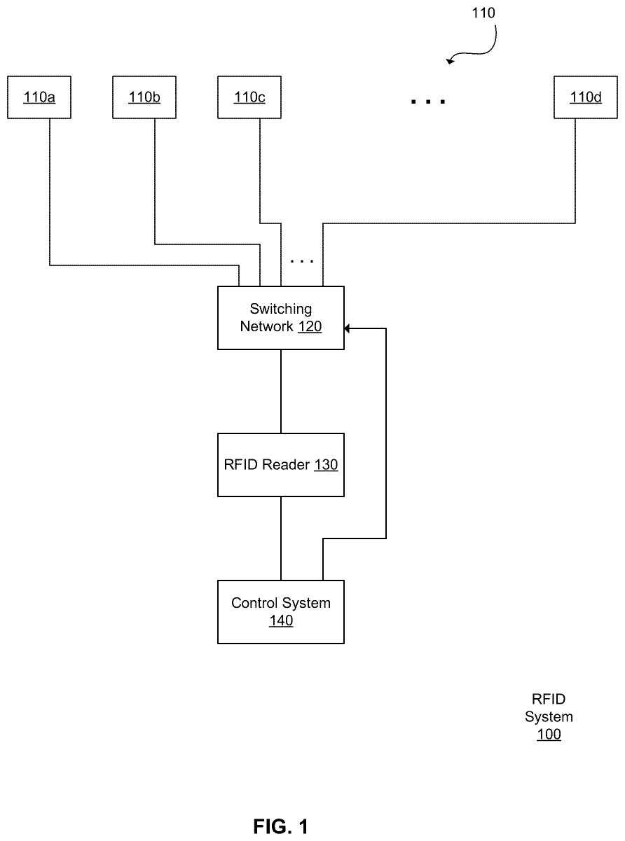

FIG. 1 is a block diagram of an RFID system 100. The RFID system 100 generally implements Sequential SPEEDscan and may be implemented as part of a gaming table, such as a Roulette table or a Craps table. The RFID system 100 includes a number of antennas 110 (four shown, 110a-110d), a switching network 120, one or more RFID readers 130 (one shown), and a control system 140.

The antennas 110 are generally located underneath the betting spots on the gaming table. For example, a betting spot for Roulette may be associated with nine antennas, corresponding to the nine locations that bets may be placed relating to that betting spot: center, the four sides, and the four corners. Each side antenna may be shared with the adjacent betting spot, and each corner antenna may be shared with the three adjacent betting spots. Other betting spots may be associated with fewer antennas than nine. For example, the spot for betting on red and the spots for betting on black may each be associated with a single, large antenna. In all, a Roulette table may have 80 or more antennas.

The switching network 120 generally provides selectable connections between the antennas 110 and the RFID reader 130, as controlled by the control system 140.

The RFID reader 130 generally transmits RFID signals using the antennas 110 and receives responses from the RFID tags that receive the RFID signals. When there are multiple RFID readers 130, this enables the RFID system 100 to transmit to multiple antennas at the same time. For example, the multiple RFID readers 130 may be connected to the antennas 110 via the switching network 120. As another example, each of the multiple RFID readers 130 may be associated with a subset of the antennas 110 via the switching network 120, which may be divided into multiple switching networks (one for each RFID reader).

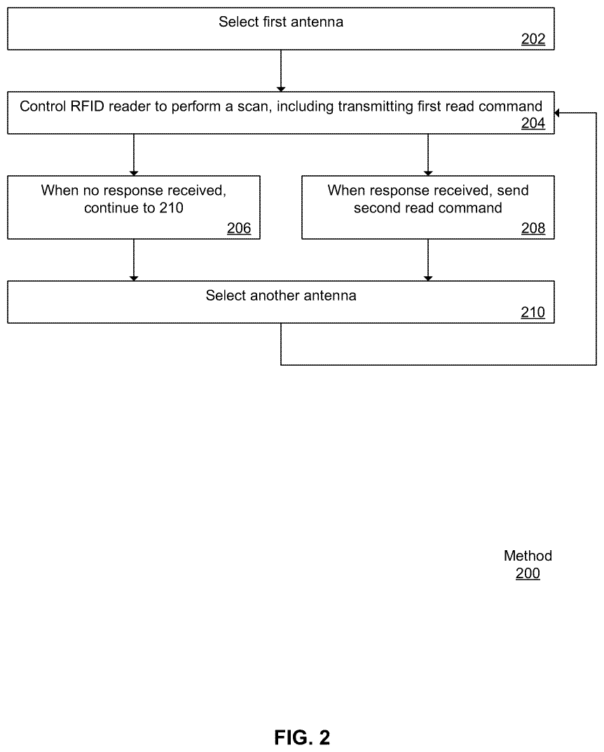

The control system 140 generally controls the RFID reader 130 to transmit the RFID signals, processes the responses from the RFID tags received by the RFID reader 130, and controls the switching network 120 to connect a selected one of the antennas 110 to the RFID reader 130. More specifically, the control system 140 implements the Sequential SPEEDscan process as described above and in FIG. 2.

FIG. 2 is a flow diagram of a method 200 of determining locations of objects in a gaming environment. The method 200 may be performed by a processor executing one or more computer programs, for example as implemented by the control system 140 (see FIG. 1). The method 200 generally describes the Sequential SPEEDscan process for the RFID system 100.

At 202, a first selected antenna of a number of RFID antennas is selected. For example, the control system 140 may control the switching network 120 to connect one of the antennas 110 to the RFID reader 130.

At 204, one or more RFID readers is controlled to perform a scan. Performing the scan includes transmitting a first read command using the selected antenna (see 202). For example, the control system 140 may control the RFID reader 130 to scan the selected antenna of the antennas 110 by transmitting a read command. The read command will either result in responses or not, as further discussed below.

At 206, when the one or more RFID readers does not receive a response to the first read command, the process continues to 210. The lack of a response indicates there are no RFID tags associated with the selected antenna. For example, when the RFID reader 130 sends a read command to the antenna 110a and does not receive a response, the control system 140 may store information indicating that there are no RFID tags in the betting spot associated with the antenna 110a. The antenna 110a then need not be further scanned. The RFID reader 130 may also terminate the read command.

At 208, when the one or more RFID readers does receive a response to the read command, the one or more RFID readers is controlled to transmit a second read command using the selected antenna (see 202). For example, when the RFID reader 130 sends a read command to the antenna 110b and does receive a response, the control system 140 may store information indicating that there are RFID tags in the betting spot associated with the antenna 110b, and may control the RFID reader 130 to transmit a second read command using the antenna 110b.

The response to the first read command includes at least part of the ITR and excludes the complete UII, and the response to the second read command includes the ITR and the complete UII. As discussed above, the ITR may include a preamble, a start of frame indicator, a checksum, and a pilot tone, and the system may use one or more of those as the response to the first read command. This enables the RFID system 100 to read RFID tags more quickly than many existing systems that spend the time to decode the complete UII, which can take quite a while when there are collisions in the responses from multiple tags. In addition, the system may achieve time savings in terminating the read command when no response is received (see 206), instead of continuing the read command for the usual time involved in receiving and processing the complete UII.

Note that the terms “first read command” and “second read command” in steps 204-208 are used as labels to help describe the process. According to an embodiment, the first read command is terminated, and the next read command that is transmitted is referred to as the “second read command”. In such a case, the first and second read commands may be conceptualized as separate commands. According to an embodiment, when the specific antenna has been identified in 208, the “first read command” need not be terminated and the “second read command” may be considered a continuation of the first read command. In such a case, the first and second read commands may be conceptualized as two phases of a single command.

At 210, another of the RFID antennas is selected, and the steps 204-208 are repeated for that selected antenna. The RFID system 100 performs the method 200 until all the antennas 110 have been scanned at 204 (and read at 208, when RFID tags were detected). This may be referred to as sequentially scanning the antennas. The method 200 may then be performed again to sequentially scan all the antennas 100 in a continuous manner.

For example, assume there are 80 antennas A1-A80. The RFID system 100 starts at 202 by selecting A1 and performs steps 204-208, then at 210 selects A2 and performs the steps 204-208, etc. for the remaining antennas A3-A80. The RFID system 100 may then repeats the method 200, starting with A1, to perform the sequential scan in a continuous manner for all the antennas A1-A80.

The above process is referred to as Sequential SPEEDscan because the method 200 energizes one antenna at a time. Multiplexed SPEEDscan and Dynamic SPEEDscan may energize more than one antenna at a time, as detailed below.

### Multiplexed SPEEDscan

The system need not limit the scanning to determine “tag present” to just one antenna at a time. Specifically, if the objective of a scan is just to determine which antennas have tags and which do not, the system can share the power level of the excitation field across multiple antennas simultaneously and then can use binary search methods to determine which antennas have tags present. The ability to tailor the power level of each antenna can aid in optimizing the excitation fields.

The following steps provide the details for the process with this added capability. First, the system determines if at least one tag is present amongst any of a selected set of multiple antennas using an INVENTORY command. As noted above, the system only needs to receive the “preamble” from an RFID tag near any of the selected antennas. No decoding of the UII is required at this stage. Furthermore, the system may do this at low power. In one embodiment, this low-power inventory command is sent to 8 antennas simultaneously.

Second, once the presence of a tag is determined to exist somewhere amongst the selected antennas, the INVENTORY command is terminated. This minimizes the time spent (“overhead”) between subsequent INVENTORY commands.

Third, binary search methods—heretofore never applied to active gaming scenarios—are then applied to determine exactly which antennas have tags present and which do not.

Fourth, the system directs an INVENTORY command at full-power to those antennas where tags are known to be present, to determine the complete UII for the tags associated with each individual antenna.

The system then repeats this process for other sets of antennas in the array.

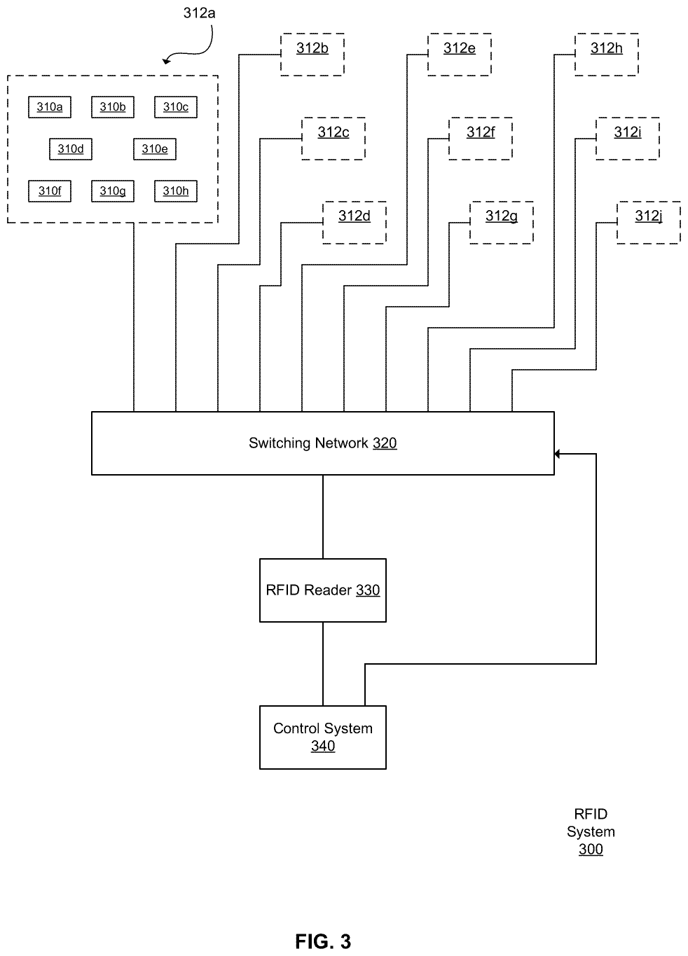

FIG. 3 is a block diagram of an RFID system 300. The RFID system 300 generally implements Multiplexed SPEEDscan and may be implemented as part of a gaming table, such as a Roulette table or a Craps table. The RFID system 300 includes a number of antennas 310 in a number of groups 312. In this embodiment, one group of 8 antennas is shown (310a-310h), and there are 10 groups 312a-312j of antennas, for 80 antennas in total. The RFID system 300 also includes a switching network 320, one or more RFID readers 330 (one shown), and a control system 340. The components of the RFID system 300 are similar to those of the RFID system 100 (see FIG. 1), with the differences noted below.

Each of the antennas 310 are individually addressable via the switching network 320 controlled by the control system 140. (To reduce clutter, only the connections from the switching network 320 to the groups 312 are shown, not the connections to the individual antennas 310 from the switching network 320.) Depending on the switch settings in the switching network 320, one or more of the antennas 310 are connected to the RFID reader 330. The control system 340 uses the ITR signal from any RFID tag(s) on the selected antennas in combination with binary search methods to determine which antennas have RFID tags present. The RFID reader 330 then processes the DATA signals for those antennas where tags are present.

This basic architecture is scalable to any number of antennas but-as is the case with any application of binary search algorithms, there is an optimum based on the expected number of tags.

In one embodiment, the control system 340 controls the RFID reader 330 to excite, via the switching network 320, 8 antennas (e.g., 310a-310h) at one time and-using the ITR response described above-the RFID system 300 determines whether or not a tag is present on one or more of the 8 antennas. If the answer is “no” (i.e., no tags on any of the addressed antennas), the control system 140 then addresses the next group of antennas, thereby reducing the read cycle time. If the answer is “yes”, the control system 340 then applies binary search techniques to address 2 groups of 4 antennas and ultimately, individual antennas to answer the question, “Where are the tags?” Once the control system 340 has identified those antennas with tags, the DATA from each tag can be read and associated with its respective antenna. Focusing the DATA component of the read cycle only on those antennas with tags greatly speeds up the overall read cycle. This technique is referred to as Multiplexed SPEEDscan because more than one antenna may be scanned at a time, in contrast to Sequential SPEEDscan which scans one antenna at a time.

As discussed above, the search procedure may be a binary search. Other search procedures may be used in other embodiments, such as a tree search and a hash function search. A tree search is similar to a binary search, however the subsets are not limited to powers of two. Such a search may be more appropriate than a binary search in cases where there is historical knowledge that certain antennas are more likely or are less likely to have associated tags, in which case the antennas with less likelihood may be grouped into larger groups, and the antennas with greater likelihood may be grouped into smaller groups. A hash function search similarly arranges the subsets into different numbers of antennas.

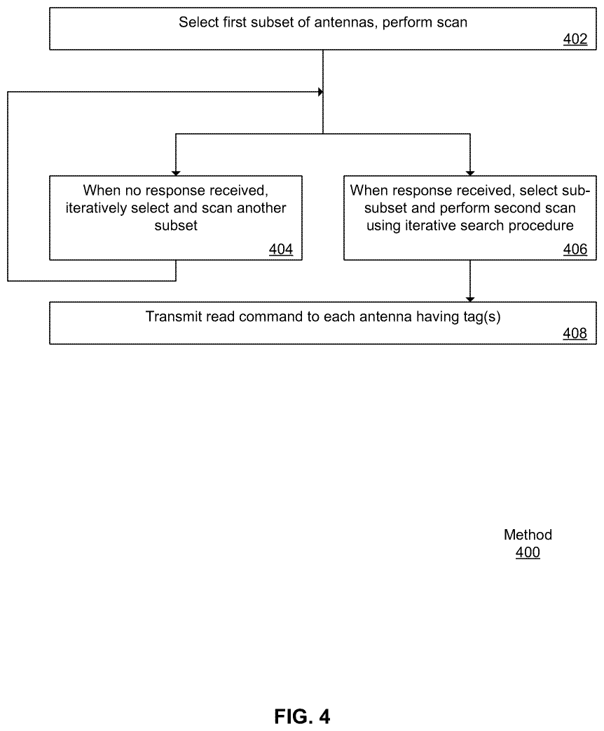

FIG. 4 is a flow diagram of a method 400 of determining locations of objects in a gaming environment. The method 400 may be performed by a processor executing one or more computer programs, for example as implemented by the control system 340 (see FIG. 3). The method 400 generally describes the Multiplexed SPEEDscan process for the RFID system 300. The steps of the method 400 are generally similar to those of the method 200 (see FIG. 2).

At 402, a first subset of RFID antennas is selected according to a search procedure, and one or more RFID readers is controlled to perform a scan. The first subset includes two or more of a number of RFID antennas, and performing the scan includes transmitting a first read command using the first subset. For example, the control system 340 (see FIG. 3) may select the group 312a including the antennas 310a-310h and may control the RFID reader 330 to perform a scan of the selected antennas via the switching network 320.

At 404, when the one or more RFID readers does not receive a response to the first read command, a second subset of the RFID antennas is selected according to the search procedure. The second subset excludes the first subset. For example, when the RFID reader 330 does not receive a response to the first read command as a result of scanning the group 312a, the control system 340 selects another subset of antennas (e.g., the group 312b). The RFID reader 330 may also terminate the read command. The control system 340 may also store information indicating that no RFID tags are associated with the antennas 310a-310h in the group 312a. The search procedure iterates through different subsets of antennas, sending read commands until all the antennas have been scanned (or a response is received).

At 406, when the one or more RFID readers does receive a response to the first read command, a sub-subset of the first subset is selected according to the search procedure, and the one or more RFID readers are controlled to perform a second scan. Performing the second scan includes transmitting a second read command using the sub-subset. For example, when the RFID reader 330 does receive a response to the first read command, the control system 340 selects a sub-subset of antennas (e.g., 310a, 310b, 310c and 310d) and controls the RFID reader 330 to perform a scan of those antennas.

As per the search procedure, the step 406 iteratively scans through different sub-subsets until the specific antenna (or antennas) associated with RFID tags are identified. For example, assume an RFID tag is associated with the antenna 310h, and that this information is unknown to the system. Starting with the eight antennas in the group 312a, the system iterates through the two subsets of four antennas, e.g. 310a-310d and 310e-310h. The subset containing 310a-310d has no tags, so the system iterates through the two subsets of two antennas for 310e-310h, e.g. 310c-310f and 310g-310h. The subset containing 310e-310f has no tags, so the system iterates through the two subsets of one antenna for 310g-310h, namely 310g and 310h. The subset containing 310g has no tags, and the subset containing 310h is identified as being associated with the RFID tag. These subsets have a single antenna so the iterative search procedure ends. Similar results occur when multiple antennas in the first subset are associated with RFID tags. In this manner, the system identifies those antennas that have tags. The system may also terminate each read command as part of each scan when no response is received.

At 408, when a specific antenna of the sub-subset with at least one RFID tag has been identified, the one or more RFID readers is controlled to transmit a third read command using the specific antenna. For example, when the antenna 310h has been identified as being associated with an RFID tag, the control system 340 controls the RFID reader 330 to transmit a third read command via the switching network 320 using the antenna 310h. In this manner, the system reads the antennas associated with tags.

The response to the first and second read commands includes at least part of the ITR and excludes the complete UII for a given RFID tag. The response to the third read command includes the ITR and the complete UII for the given RFID tag. As discussed above regarding Sequential SPEEDscan, this enables the system to quickly determine which antennas have tags (steps 404-406), and to spend the time involved in a longer, complete read only using those antennas associated with tags (step 408). In addition, the system may achieve time savings in terminating the read command when no response is received (see 404 and 406), instead of continuing the read command for the usual time involved in receiving and processing the complete UII.

Note that the terms “second read command” and “third read command” in steps 406-408 are used as labels to help describe the process. According to an embodiment, the second read command is terminated, and the next read command that is transmitted is referred to as the “third read command”. In such a case, the second and third read commands may be conceptualized as separate commands. According to an embodiment, when the specific antenna has been identified in 408, the “second read command” need not be terminated and the “third read command” may be considered a continuation of the second read command. In such a case, the “second” and “third” read commands may be conceptualized as two phases of a single command.

### Dynamic SPEEDscan

As Sequential SPEEDscan scans one antenna at a time, and Multiplexed SPEEDscan scans multiple antennas at a time, Dynamic SPEEDscan uses the information from previous scans to direct the current scan.

Once the system has obtained a baseline understanding of which antennas have tags and which do not using an initial scan, the system can take advantage of this knowledge in subsequent read cycles by directing the SPEEDscan process to scan only those antennas that were identified as “no tags present”. Doing so will highlight only those antennas that have experienced a change from “no tags present” to “tags present”. Because the number of antennas experiencing a change at any one time (between 2 scans) is small, the efficiency of this embodiment increases dramatically. The RFID reader continues to monitor all antennas with tags present using the DATA part of the tag response-but again, this is a very focused and efficient use of the RFID reader.

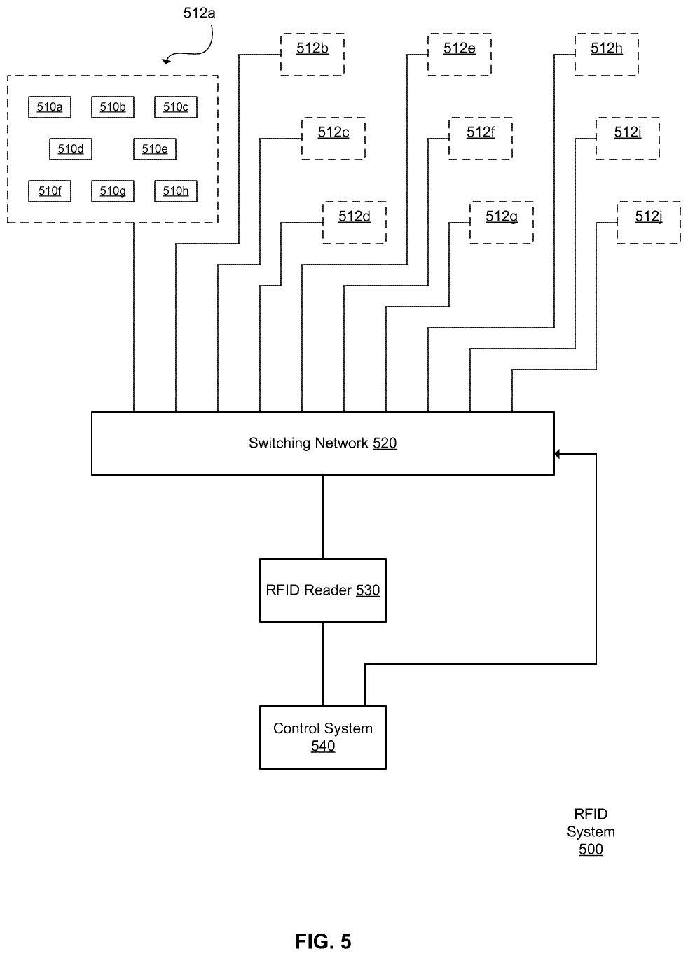

FIG. 5 is a block diagram of an RFID system 500. The RFID system 500 generally implements Dynamic SPEEDscan and may be implemented as part of a gaming table, such as a Roulette table or a Craps table. The RFID system 500 includes a number of antennas 510 in a number of groups 512. In this embodiment, one group of 8 antennas is shown (510a-350h), and there are 10 groups 512a-512j of antennas, for 80 antennas in total. The RFID system 500 also includes a switching network 520, one or more RFID readers 530 (one shown), and a control system 540. The components of the RFID system 500 are similar to those of the RFID system 300 (see FIG. 3), with the differences noted below.

The control system 540 includes a memory that stores information indicating which of the antennas 510 are associated with RFID tags and which are not. Initially, this information may be undefined, but after an initial scan, the control system 540 knows which of the antennas 510 are associated with RFID tags and which are not. This information enables the RFID system 500 to more efficiently scan the antennas, as discussed above. The RFID system 500 additionally may implement the iterative scanning process of the RFID system 300 (see FIG. 3) and as described for the method 400 (see FIG. 4).

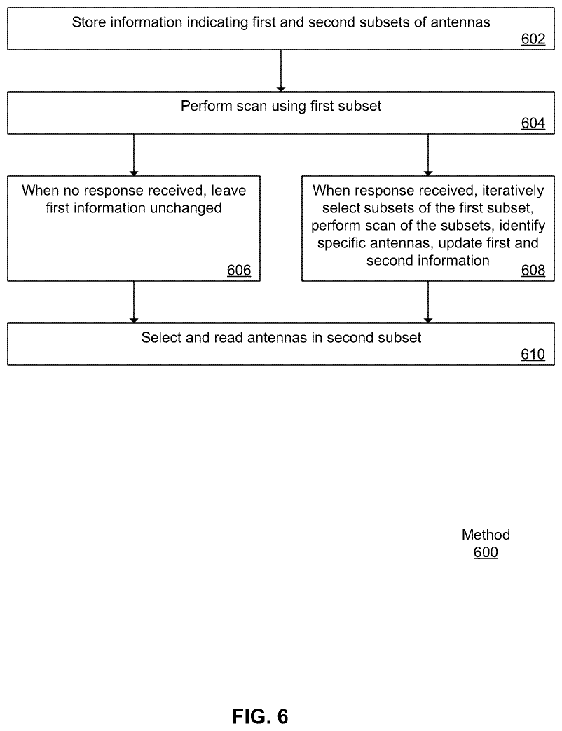

FIG. 6 is a flow diagram of a method 600 of determining locations of objects in a gaming environment. The method 600 may be performed by a processor executing one or more computer programs, for example as implemented by the control system 540 (see FIG. 5). The method 600 generally describes the Dynamic SPEEDscan process for the RFID system 500. The steps of the method 600 are generally similar to those of the method 200 (see FIG. 2) and the method 400 (see FIG. 4).

At 602, first information indicating a first subset of a number of RFID antennas is stored, and second information indicating a second subset of the RFID antennas is stored. Each RFID antenna in the first subset is associated with no RFID tags, and each RFID antenna in the second subset is associated with at least one RFID tag. In other words, this information indicates which of the RFID antennas are (currently) associated with RFID tags, and which are (currently) not associated with any RFID tags. For example, the control system 540 (see FIG. 5) may store the first information that indicates which of the antennas 510 are not associated with RFID tags and the second information that indicates which of the RFID antennas 510 are associated with RFID tags.

At 604, one or more RFID readers is controlled to perform a scan using the first subset of antennas, where performing the scan includes transmitting a read command using the first subset. For example, the control system 540 controls the RFID reader 530 to perform a scan using the first subset of the antennas 510 (i.e., the ones not associated with RFID tags).

The first subset may include multiple subsets. For example, if there are 100 RFID antennas in total, and 80 in the first subset (having no RFID tags), there are many options for the system to query those 80 antennas. For example, the system may query 4 subsets of 20 antennas each, 8 subsets of 10 antennas each, etc.

At 606, when the one or more RFID readers does not receive a response to the read command (see 604), the first information is left unchanged. In other words, no response is received because no RFID tags have been placed nearby the antennas in the first subset since the previous scan. For example, when the RFID reader 530 does not receive a response to the first read command, the control system 540 does not change the first information.

At 608, when the one or more RFID readers does receive the response to the read command (see 604), subsets of the first subset are iteratively selected, the one or more RFID readers are controlled to perform the scan of the subsets having been iteratively selected, one or more specific antennas each having at least one RFID tag are identified based on a response to the scan, the first information is updated to delete the one or more specific antennas, and the second information is updated to add the one or more specific antennas. The iterative selection of the antennas and the scanning may be performed in a manner similar to that described above regarding Multiplexed SPEEDscan, e.g. at 406 in FIG. 4. The response to the read command includes at least part of an ITR and excludes a complete UII for a given RFID tag. As discussed above, receiving part of the ITR without spending the time to receive and decode the complete UII enables the system to quickly identify the presence of RFID tags.

For example, when the RFID reader 530 does receive the response to the read command, the control system 540 iteratively selects subsets of the first subset, controls the

RFID reader 530 to perform the scan of the subsets having been iteratively selected, identifies one or more specific antennas of the antennas 510 each having at least one RFID tag based on a response to the scan, updates the first information to delete the one or more specific antennas, and updates the second information to add the one or more specific antennas.

At 610, a selected antenna from the second subset is selected, and the one or more RFID readers are controlled to transmit a second read command using the selected antenna. The response to the second read command includes the ITR and the complete UII for the given RFID tag. The system may iterate through all the antennas in the second subset in a similar manner. As a result, the full reads can be performed only on those antennas known to have associated RFID tags, which saves time as compared to many existing systems that perform a full read for each antenna.

For example, assume that as a result of steps 602-608 the control system 540 knows that RFID tags are associated with antennas 510a and 510g. The control system 540 selects one of those antennas (e.g., 510a) and controls the RFID reader 530 to transmit a read command using the antenna 510a. The responses to this read command from the associated RFID tags include the complete UII for each tag. The control system 540 then selects the other antenna (e.g., 510g) for reading in a similar manner.

### Using the Information Regarding Presence and Absence of Chips

Storing the information that RFID tags are not present or are present (see 602) enables the RFID system 500 to scan the antennas at different rates. For example, the method 600 may be performed on the antennas with tags not present twice as often as it is performed on the antennas with tags present. This enables the RFID system 100 to more quickly recognize the moment at which RFID tags are placed on the betting spot and to quickly transmit a read command using that antenna to read the RFID tags.

For example, assume there are 80 antennas A1-A80. As a result of iteratively scanning the 80 antennas (see 604-608), the RFID system 100 stores information indicating that antennas A1-A60 have no associated RFID tags, and that antennas A61-A80 have associated RFID tags. The RFID system 100 may then scan the antennas A1-A60 in a single pass (which in a practical way may include multiple reads) to detect any change prior to scanning the antennas A61-A80. This enables the RFID system 100 to more quickly detect the presence of an RFID tag in the group that previously had no associated RFID tags.

### Example for Dynamic SPEEDscan

Assume the following setup: 80 antennas, 20 RFID tags total in 4 stacks of 5 tags each, Tag ID (UII) read in 10 milliseconds/tag, and detection occurs in 2.5 milliseconds with 8 antennas queried simultaneously. TABLE 1 shows the expected read cycle time without SPEEDscan as a reference and compares it with 3 scenarios using Dynamic SPEEDscan.

TABLE 1

| Scenario | Time | |
|---|---|---|
| Without SPEEDscan | 1 | second |
| Baseline SPEEDscan (worst case) | 475 | msec |
| SPEEDscan with no change from previous | 225 | msec |
| read (best case) | | |
| SPEEDscan with 1 change from previous read | 237 | msec |

(typical case)

The scenario without SPEEDscan takes 1 second due to the time involved in reading each antenna whether or not tags are present at a given antenna, as well as the time to receive the responses from the tags and decode the UII. The baseline SPEEDscan takes a bit longer due to the lack of a priori information regarding which antennas have tags and which do not, so the full steps 602-610 (see FIG. 6) are performed. With no change from previous, the scan of the antennas that previously had no tags takes only a short time because they still have no tags (steps 604-606), and the additional time is spent just reading the antennas that previously had tags (step 610). With 1 change from previous, the scan of the antennas that previously had no tags takes a bit longer in the case that one of those antennas now has a tag (step 608), and reading the antennas that previously had tags is performed as usual (step 610).

### Gameplay Example

One benefit of SPEEDscan is that enables the system to quickly read a subset of antennas based on external triggers (e.g., after a change in game state).

Payouts of winning bets is one of the most difficult events to capture. The dealer's activities are asynchronous with scanning and a player is often keen to gather their winnings quickly. Embodiments of SPEEDscan track the game state and adjust the scanning algorithm once the game logic (described above) transitions to the Payout game state.

At the start of Payout, the outcome of the game is known and the winning bets have been identified. Typically, the dealer is trained to make payouts to winning bets in specific pre-defined areas. Using SPEEDscan, the RFID system can identify any changes in the payout spot(s) quickly to capture these events, despite having many antennas and other chips on the table. For example, during the Payout state, the antennas known to have no chips need not be included in the scanning process. Furthermore, if the payout sequence is known (e.g. all losing bets cleared first, all payouts done left-to-right, etc.), the control system can prioritize looking for “events” on specific antennas.

### Additional Embodiments

The previous embodiments have not discussed impedance matching. In those embodiments, the impedance matching may be set based on median expected use cases. However, the impedance of the antennas may be affected both by the number of RFID tags at each antenna (for the RFID systems 100, 300 and 500) as well as by the number of antennas being scanned at one time (for the RFID systems 300 and 500). To improve the impedance matching, an impedance matching network may be added to any of the above embodiments.

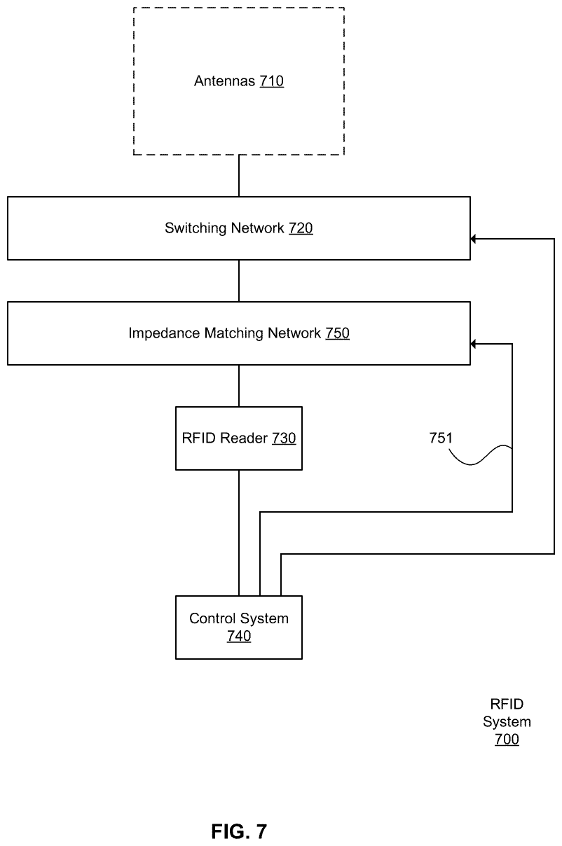

FIG. 7 is a block diagram of an RFID system 700. The RFID system 700 includes antennas 710, a switching network 720, one or more RFID readers 730, and a control system 740. These components are similar to those of the RFID system 100 (see FIG. 1), the RFID system 300 (see FIG. 3), and the RFID system 500 (see FIG. 5). That is, the RFID system 700 may implement any of Sequential SPEEDscan, Multiplexed SPEEDscan and Dynamic SPEEDscan. The RFID system 700 additionally includes an impedance matching network 750 between the one or more RFID readers 730 and the antennas 710. As shown in FIG. 7, the impedance matching network 750 is between the one or more RFID readers 730 and the switching network 720. In another embodiment, the impedance matching network 750 may be placed between the switching network 720 and the antennas 710. In another embodiment, the impedance matching network 750 may be placed both between the one or more RFID readers 730 and the switching network 720, and between the switching network 720 and the antennas 710.

The control system 740 sends a control signal 751 to the impedance matching network 750 to configure the impedance matching network 750 appropriately for the excitation by the one or more RFID readers 730. The impedance matching may vary depending on both the expected number of RFID tags and the number of antennas selected for excitation. The control system 740 may adjust the impedance of the impedance matching network 750 during operation of the RFID system 700, e.g. between or during reads by the RFID reader 730. This adjustment of the impedance during operation of the system may be referred to as dynamic adjustment of the impedance.

In one embodiment, the control system 740 uses a lookup table to configure the impedance matching network 750. The matching network 750 may include a set of series components and a series of shunt components. The series components may include resistors, capacitors and inductors, and the shunt components may include resistors, capacitors and inductors. For example, the series components may include 4 capacitors giving 16 selectable capacitance value combinations, and the shunt components may include 5 capacitors giving 32 selectable capacitance value combinations. The lookup table stores the appropriate combinations of the series components and the shunt components for each possible selectable subset of the antennas, so that the reactance of the selected subset of antennas is matched. The matching reactance for each selectable subset of antennas may be determined empirically when the system is configured. An example of a suitable matching network can be seen in FIG. 7 of U.S. Pat. No. 11,630,964 (note the reactance network 708a in a series configuration and the reactance network 708b in a shunt configuration).

In another embodiment, the control system 740 uses a network analyzer to configure the impedance matching network 750. Within each read cycle, the control system 740 controls the network analyzer to measure the scattering parameter S11. Based on the measured S11, the control system 740 configures the matching network 750 in a manner similar to that described above regarding the lookup table. Measuring the scattering parameter S11 adds minimal time to the read cycle—typically 100 microseconds.

The impedance matching network 750 may also be used during operation of the method 200 (see FIG. 2), the method 400 (see FIG. 4) and the method 600 (see FIG. 6). For example, when the first selected antenna is selected (see 202), the impedance matching network may be controlled to change an impedance to match that of the first selected antenna. As another example, when the first subset of RFID antennas is selected (see 402), the impedance matching network may be controlled to change an impedance to match that of the first subset. As another example, when the second subset of RFID antennas is selected (see 404), the impedance matching network may be controlled to change an impedance to match that of the second subset. As another example, when the one or more RFID readers is controlled to perform a scan using the first subset of antennas (see 604), the impedance matching network may be controlled to change an impedance to match that of the first subset of antennas.

### Enumerated Example Embodiments

Various aspects of the present invention may be appreciated from the following enumerated example embodiments (EEEs).
EEE B1. A system for determining locations of objects in a gaming environment, the system comprising: a plurality of radio-frequency identification (RFID) antennas arranged at a plurality of locations on a gaming table; one or more RFID readers coupled to the plurality of RFID antennas; and a control system that selects a first subset of the plurality of RFID antennas according to a search procedure and controls the one or more RFID readers to perform a scan, wherein the first subset includes two or more of the plurality of RFID antennas, and wherein performing the scan includes transmitting a first read command using the first subset. When the one or more RFID readers does not receive a response to the first read command, the control system selects a second subset of the plurality of RFID antennas according to the search procedure, wherein the second subset excludes the first subset. When the one or more RFID readers does receive the response to the first read command, the control system selects a sub-subset of the first subset according to the search procedure and controls the one or more RFID readers to perform a second scan, wherein performing the second scan includes transmitting a second read command using the sub-subset. When the control system has identified a specific antenna of the sub-subset with at least one RFID tag, the control system controls the one or more RFID readers to transmit a third read command using the specific antenna. The response to the first read command includes at least part of an initial tag response and excludes a complete unique item identifier for a given RFID tag, the response to the second read command includes at least part of the initial tag response and excludes the complete unique item identifier for the given RFID tag, and the response to the third read command includes the initial tag response and the complete unique item identifier for the given RFID tag.
EEE B2. The system of EEE B1, wherein the search procedure is one of a binary search, a tree search, and a hash function search.
EEE B3. The system of EEE B1, wherein the control system iteratively selects a given subset of the plurality of RFID antennas from a previously-given subset.
EEE B4. The system of EEE B1, wherein the first subset includes two or more of the plurality of RFID antennas, and wherein the sub-subset of the first subset includes fewer of the plurality of RFID antennas than the first subset.
EEE B5. The system of EEE B1, wherein the control system iteratively selects subsets of the plurality of antennas, controls the one or more RFID readers to perform the scan, and identifies a plurality of specific antennas each having at least one RFID tag based on a response to the scan; wherein the control system transmits a corresponding read command using each of the plurality of specific antennas; and wherein the response to the corresponding read command using each of the plurality of specific antennas includes the initial tag response and the complete unique item identifier for the at least one RFID tag associated with each of the plurality of specific antennas.
EEE B6. The system of EEE B1, further comprising: a switching network, coupled between the one or more RFID readers and the plurality of RFID antennas, wherein the control system selects the first subset by controlling the switching network to connect the one or more RFID readers and the first subset, and selects the second subset by controlling the switching network to connect the one or more RFID readers and the second subset.
EEE B7. The system of EEE B1, further comprising: an impedance matching network, coupled between the one or more RFID readers and the plurality of RFID antennas, that is configured to receive a control signal from the control system, wherein the control system uses the control signal to change an impedance of the impedance matching network during operation of the system.
EEE B8. The system of EEE B1, wherein the control system controls the one or more RFID readers to transmit the first read command at low power, wherein the low power is less than full power.
EEE B9. The system of EEE B1, wherein the control system controls the one or more RFID readers to transmit the first read command at full power.
EEE B10. A method of determining locations of objects in a gaming environment, the method comprising: providing a plurality of radio-frequency identification (RFID) antennas arranged at a plurality of locations on a gaming table; providing one or more RFID readers coupled to the plurality of RFID antennas; providing a control system; selecting, by the control system, a first subset of the plurality of RFID antennas according to a search procedure, wherein the first subset includes two or more of the plurality of RFID antennas; controlling, by the control system, the one or more RFID readers to perform a scan, wherein performing the scan includes transmitting a first read command using the first subset; when the one or more RFID readers does not receive a response to the first read command: selecting, by the control system, a second subset of the plurality of RFID antennas according to the search procedure, wherein the second subset excludes the first subset; when the one or more RFID readers does receive the response to the first read command: selecting, by the control system, a sub-subset of the first subset according to the search procedure, and controlling, by the control system, the one or more RFID readers to perform a second scan, wherein performing the second scan includes transmitting a second read command using the sub-subset; and when the control system has identified a specific antenna of the sub-subset with at least one RFID tag: controlling, by the control system, the one or more RFID readers to transmit a third read command using the specific antenna. The response to the first read command includes at least part of an initial tag response and excludes a complete unique item identifier for a given RFID tag, the response to the second read command includes at least part of the initial tag response and excludes the complete unique item identifier for the given RFID tag, and the response to the third read command includes the initial tag response and the complete unique item identifier for the given RFID tag.
EEE C1. A system for determining locations of objects in a gaming environment, the system comprising: a plurality of radio-frequency identification (RFID) antennas arranged at a plurality of locations on a gaming table; one or more RFID readers coupled to the plurality of RFID antennas; and a control system that stores first information indicating a first subset of the plurality of RFID antennas and second information indicating a second subset of the plurality of RFID antennas, wherein each RFID antenna in the first subset is associated with no RFID tags, and wherein each RFID antenna in the second subset is associated with at least one RFID tag. The control system controls the one or more RFID readers to perform a scan using the first subset, wherein performing the scan includes transmitting a read command using the first subset. When the one or more RFID readers does not receive a response to the read command, the control system leaves unchanged the first information. When the one or more RFID readers does receive the response to the read command, the control system iteratively selects subsets of the first subset, controls the one or more RFID readers to perform the scan of the subsets having been iteratively selected, identifies one or more specific antennas each having at least one RFID tag based on a response to the scan, updates the first information to delete the one or more specific antennas, and updates the second information to add the one or more specific antennas. The response to the read command includes at least part of an initial tag response and excludes a complete unique item identifier for a given RFID tag.
EEE C2. The system of EEE C1, wherein the control system selects a selected antenna from the second subset and controls the one or more RFID readers to transmit a second read command using the selected antenna, wherein the response to the second read command includes the initial tag response and the complete unique item identifier for the given RFID tag.
EEE C3. The system of EEE C1, wherein the control system stores information indicating a plurality of game states, wherein the control system controls the one or more RFID readers to perform a scan using the first subset based on a change from one game state to another game state.
EEE C4. The system of EEE C1, further comprising: a switching network, coupled between the one or more RFID readers and the plurality of RFID antennas, wherein the control system controls the one or more RFID readers to perform a scan using the first subset by controlling the switching network to connect the one or more RFID readers and the first subset.
EEE C5. The system of EEE C1, further comprising: an impedance matching network, coupled between the one or more RFID readers and the switching network, that is configured to receive a control signal from the control system, wherein the control system uses the control signal to change an impedance of the impedance matching network during operation of the system.
EEE C6. The system of EEE C1, wherein the control system controls the one or more RFID readers to transmit the read command at low power, wherein the low power is less than full power.
EEE C7. The system of EEE C1, wherein the control system controls the one or more RFID readers to transmit the read command at full power.
EEE C8. A method of determining locations of objects in a gaming environment, the method comprising: providing a plurality of radio-frequency identification (RFID) antennas arranged at a plurality of locations on a gaming table; providing one or more RFID readers coupled to the plurality of RFID antennas; providing a control system; storing, by the control system, first information indicating a first subset of the plurality of RFID antennas and second information indicating a second subset of the plurality of RFID antennas, wherein each RFID antenna in the first subset is associated with no RFID tags, and wherein each RFID antenna in the second subset is associated with at least one RFID tag; controlling, by the control system, the one or more RFID readers to perform a scan using the first subset, wherein performing the scan includes transmitting a read command using the first subset. When the one or more RFID readers does not receive a response to the read command: leaving unchanged, by the control system, the first information. When the one or more RFID readers does receive the response to the read command: iteratively selecting, by the control system, subsets of the first subset; controlling, by the control system, the one or more RFID readers to perform the scan of the subsets having been iteratively selected; identifying, by the control system, one or more specific antennas each having at least one RFID tag based on a response to the scan; updating, by the control system, the first information to delete the one or more specific antennas; and updating, by the control system, the second information to add the one or more specific antennas. The response to the read command includes at least part of an initial tag response and excludes a complete unique item identifier for a given RFID tag.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A system for determining locations of objects in a gaming environment, the system comprising:
a plurality of radio-frequency identification (RFID) antennas arranged at a plurality of locations on a gaming table;
one or more RFID readers coupled to the plurality of RFID antennas; and
a control system that selects a first selected antenna of the plurality of RFID antennas and controls the one or more RFID readers to perform a scan, wherein performing the scan includes transmitting a first read command using the first selected antenna,
wherein when the one or more RFID readers does not receive a response to the first read command, the control system selects a second selected antenna for scanning,
wherein when the one or more RFID readers does receive the response to the first read command, the control system controls the one or more RFID readers to transmit a second read command using the first selected antenna,
wherein the response to the first read command includes at least part of an initial tag response and excludes a complete unique item identifier for a given RFID tag, and
wherein the response to the second read command includes the initial tag response and the complete unique item identifier for the given RFID tag.

2. The system of claim 1, wherein the control system controls the one or more RFID readers to transmit the first read command at low power, wherein the low power is less than full power.

3. The system of claim 1, wherein the control system controls the one or more RFID readers to transmit the first read command at full power.

4. The system of claim 1, wherein the initial tag response includes one or more of a preamble portion, a start of frame portion, a checksum portion and a pilot tone portion.

5. The system of claim 1, wherein the control system controls the one or more RFID readers to perform a second scan on the second selected antenna.

6. The system of claim 1, wherein the control system controls the one or more RFID readers to perform a plurality of scans on the plurality of RFID antennas.

7. The system of claim 1, wherein the control system controls the one or more RFID readers to perform a plurality of scans, wherein performing the plurality of scans includes sequentially scanning each of the plurality of RFID antennas.

8. The system of claim 1, wherein the control system controls the one or more RFID readers to transmit at a selectable power level.

9. The system of claim 1, wherein the control system controls the one or more RFID readers to transmit at a selectable power level for each of the one or more RFID readers.

10. The system of claim 1, wherein the control system controls the one or more RFID readers to terminate the first read command after receiving the response to the first read command.

11. The system of claim 1, further comprising:
a switching network, coupled between the one or more RFID readers and the plurality of RFID antennas,
wherein the control system selects the first selected antenna by controlling the switching network to connect the one or more RFID readers and the first selected antenna.

12. The system of claim 1, further comprising:
an impedance matching network, coupled between the one or more RFID readers and the plurality of RFID antennas, that is configured to receive a control signal from the control system,
wherein the control system uses the control signal to change an impedance of the impedance matching network during operation of the system.

13. A method of determining locations of objects in a gaming environment, the method comprising:
providing a plurality of radio-frequency identification (RFID) antennas arranged at a plurality of locations on a gaming table;
providing one or more RFID readers coupled to the plurality of RFID antennas;
providing a control system;
selecting, by the control system, a first selected antenna of the plurality of RFID antennas;
controlling, by the control system, the one or more RFID readers to perform a scan, wherein performing the scan includes transmitting a first read command using the first selected antenna;
when the one or more RFID readers does not receive a response to the first read command:
selecting, by the control system, a second selected antenna for scanning; and
when the one or more RFID readers does receive the response to the first read command:
controlling, by the control system, the one or more RFID readers to transmit a second read command using the first selected antenna,
wherein the response to the first read command includes at least part of an initial tag response and excludes a complete unique item identifier for a given RFID tag, and
wherein the response to the second read command includes the initial tag response and the complete unique item identifier for the given RFID tag.

14. The method of claim 13, wherein transmitting the first read command comprises transmitting the first read command at low power, wherein the low power is less than full power.

15. The method of claim 13, further comprising:
performing a plurality of scans on the plurality of RFID antennas.

16. The method of claim 13, further comprising:
performing a plurality of scans, wherein performing the plurality of scans includes sequentially scanning each of the plurality of RFID antennas.

17. The method of claim 13, further comprising:
changing an impedance of an impedance matching network coupled between the one or more RFID readers and the plurality of RFID antennas during operation of the control system.

18. A system for determining locations of objects in a gaming environment, the system comprising:
a gaming table;
a plurality of radio-frequency identification (RFID) antennas arranged at a plurality of locations on the gaming table;
one or more RFID readers coupled to the plurality of RFID antennas; and
a control system that selects a first selected antenna of the plurality of RFID antennas and controls the one or more RFID readers to perform a scan, wherein performing the scan includes transmitting a first read command using the first selected antenna,
wherein when the one or more RFID readers does not receive a response to the first read command, the control system selects a second selected antenna for scanning,
wherein when the one or more RFID readers does receive the response to the first read command, the control system controls the one or more RFID readers to transmit a second read command using the first selected antenna,
wherein the response to the first read command includes at least part of an initial tag response and excludes a complete unique item identifier for a given RFID tag, and
wherein the response to the second read command includes the initial tag response and the complete unique item identifier for the given RFID tag.

19. The system of claim 18, further comprising:
a switching network, coupled between the one or more RFID readers and the plurality of RFID antennas,
wherein the control system selects the first selected antenna by controlling the switching network to connect the one or more RFID readers and the first selected antenna.

20. The system of claim 18, further comprising:
an impedance matching network, coupled between the one or more RFID readers and the plurality of RFID antennas, that is configured to receive a control signal from the control system,
wherein the control system uses the control signal to change an impedance of the impedance matching network during operation of the system.
